(19) United States
(12) Patent Application Publication
(10) Pub. No.: US 2007/0131347 A1
(43) Pub. Date: Jun. 14, 2007

(54) Method of forming a fabric covered article

(75) Inventors: Klaus Boes, Beilngries (DE); Ralf Hoffmann, Munchen (DE); Markus Koidl, Munchen (DE); Michael Behnke, Munchen (DE); Karsten Muller, Ingolstadt (DE)

Correspondence Address: MACMILLAN, SOBANSKI & TODD, LLC, ONE MARITIME PLAZA-FIFTH FLOOR, 720 WATER STREET, TOLEDO, OH, 43604, US

(73) Assignee: Lear Corporation

(21) Appl. No.: 11/301,902

(22) Filed: Dec. 13, 2005

(51) Int. Cl. B32B 37/00

(52) U.S. Cl. 156/272.2

(57) ABSTRACT

A method of forming a fabric covered article includes providing a substrate and trim cover laminate. The trim cover laminate includes a trim cover portion and a heat-activated adhesive portion laminated to a B-side surface of the trim cover portion, the adhesive portion defining an exposed surface. The exposed surface of the adhesive portion is exposed to heat, thereby activating the adhesive portion. The substrate is positioned onto the activated adhesive portion of the trim cover laminate to bring the substrate and the trim cover portion into contact with one another, thereby forming a fabric covered article.

### BACKGROUND OF THE INVENTION

The present invention relates generally to a method of forming a fabric covered article, and more particularly to a method of forming articles such as vehicle seat cushions.

Various methods can be used to bond fabric to a foam pad. Such methods include placing fabric over a porous contoured mold, placing an air impervious adhesive film over the fabric, applying a vacuum to the mold to draw the adhesive film against the fabric to conform the fabric to the contour of the mold surface, placing a similarly contoured foam pad in mating engagement with the adhesive film as it is held by the vacuum, compressing the foam pad against the mold by a perforated platen, and applying steam or heated air through the foam pad to heat and diffuse the adhesive film into the fabric and foam pad to adhesively secure the two together.

### BRIEF DESCRIPTION OF THE DRAWINGS

FIG. 1 is a cross sectional elevational view of a seat cushion manufactured according to the method of this invention.

FIG. 2 is a cross sectional elevational view of a press used according to the method of this invention, showing the press in the open position.

FIG. 2A is an enlarged cross sectional view of the trim cover laminate illustrated in FIG. 2.

FIG. 3 is a cross sectional elevational view showing the press illustrated in FIG. 2 in the closed position, and showing a seat cushion therein.

FIG. 4 is a cross sectional elevational view of a press used according to a second embodiment of the method of this invention, showing the press in the open position.

### DETAILED DESCRIPTION OF THE INVENTION

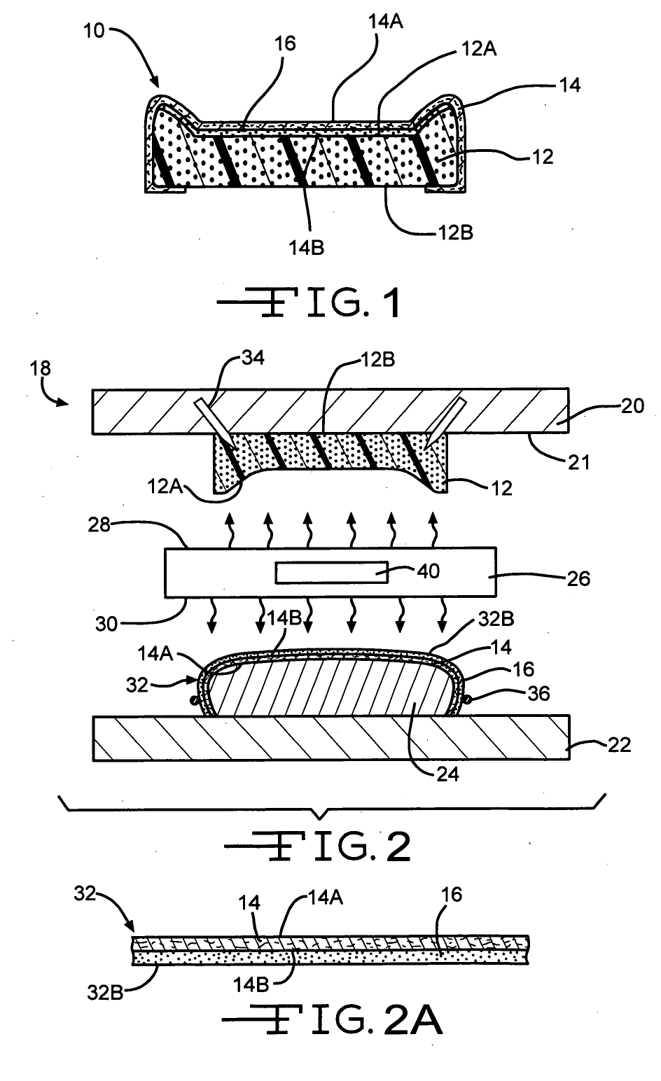

Referring now to the drawings, there is illustrated in FIG. 1 a fabric covered article, generally shown at 10. The exemplary fabric covered article 10 illustrated in FIG. 1 is seat cushion for use in a vehicle (not shown). The illustrated seat cushion 10 includes a substrate or foam pad 12. The foam pad 12 has an A-side surface 12A and a B-side surface 12B. The illustrated seat cushion 10 further includes a fabric portion, or a trim cover portion or trim cover 14 having an A-side surface 14A and a B-side surface 14B. The B-side surface 14B of the trim cover 14 may be attached to the A-side surface 12A of the foam pad 12 by an adhesive layer 16. As used herein, the A-side surface refers to the surface which is exposed to, or is oriented in the direction of, the vehicle occupant. The B-side surface refers to the surface which is opposite the A-side surface and which faces away from the vehicle occupant.

In the exemplary embodiment illustrated in FIG. 1, the adhesive layer 16 is a heat-activated adhesive portion or film 16. The adhesive film 16 may be any suitable heat-activated adhesive film 16, such as for example, thermoplastic adhesives, and reactive polyurethane adhesives with encapsulated reactive groups. Examples of such thermoplastic adhesives include polyamides, polyethylene, polyolefin, polyurethane, and the like.

The foam pad 12 may be formed from any suitable foam, such as polyurethane foam or polyethylene foam, however any other open or closed cell foam, or other desired polymer or non-polymer material may be used. As appreciated by those skilled in the art, the trim cover 14 may be fabricated from any suitable material, such as for example, vinyl, cloth, carpet, non-porous fabric, leather, or any other desired material.

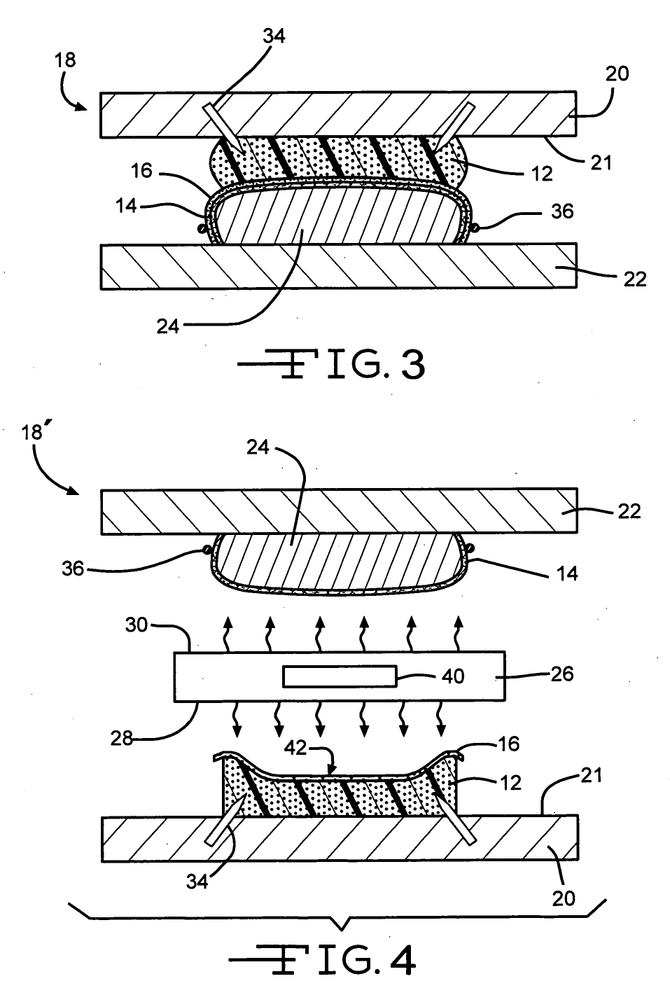

A first embodiment of the method of the invention is illustrated in FIGS. 2 and 3. Referring first to FIG. 2, there is illustrated a press indicated generally at 18, which is adapted to be used in accordance with the method a first embodiment of this invention. In the exemplary embodiment illustrated in FIG. 2, the press 18 includes a first press half 20 (upper half as viewed in FIGS. 2 and 3) having a surface 21, a second press half 22 (lower half as viewed in FIGS. 2 and 3), a trim cover support portion 24, and a source of heat 26 having first and second heat generating surfaces 28 and 30, respectively.

Although illustrated schematically in FIGS. 2 through 4, it will be appreciated that the press halves 20 and 22, and the trim cover support portion 24 may be of any desired shape and contour.

The first press half 20 and the second press half 22 may be mounted to the platens (not shown) of a press assembly (not shown) with sufficient tonnage to accomplish the method herein described. The press 18 may be moved between an open position, as shown in FIG. 2, and a closed position, as shown in FIG. 3.

In the exemplary embodiment illustrated in FIG. 2, the source of heat 26 is disposed between the first press half 20 and the second press half 22. The source of heat 26 may be any suitable source of heat sufficient to melt the heat-activated adhesive film 16, such as a source of radiant heat. In the exemplary embodiment illustrated in FIG. 2, heat is provided by a source of infrared (IR) energy 26. Radiant heat can be provided by other desired means, such as for example, a flash of high intensity heat form a light source, by a laser, or by any other desired sources of radiant heat. Other sources of heat can also be used, such as for example, natural gas or liquid propane fired heat, quartz, contact, and hot air heat systems.

According to the method of this invention, the press 18 is moved to the open position, as shown in FIG. 2. It will be appreciated that the open position can be achieved by moving the first press half 20 away relative to the second press half 22, moving the second press half 22 away relative to the first press half 20, or moving each of the first press half 20 and the second press half 22 away from the other.

In the first embodiment of the method of the invention, as best shown in FIG. 2A, the adhesive film 16 is disposed against the B-side surface 14B of the trim cover 14 and defines an exposed surface. The exposed surface of the adhesive film 16 is then exposed to an amount of heat sufficient to laminate or adhere the adhesive film 16 to the B-side surface 14B of the trim cover 14, thereby defining a trim cover laminate 32 having a B-side surface 32B. The adhesive film 16 may also be adhered to the B-side surface 14B of the trim cover 14 by any other desired means, such as adhesive. Such an adhesive may be the same as the adhesive film 16, or may be any other suitable adhesive. Alternately, the adhesive film 16 may be disposed against the B-side surface 14B of the trim cover 14, such as shown in FIG. 2, without an adhesive.

A substrate, such as the foam pad 12, may then be releasably attached to the surface 21 of the first press half 20. The first press half 20 includes means for attaching the foam pad 12 to the surface 21. In the illustrated embodiment, the foam pad 12 is releasably attached to the first press half 20 by studs or needles 34, however any other desired means may be used. For example, the surface 21 of the first press half 20 may be provided with a surface shape or contour corresponding with the shape or contour of the B-side surface 12B of the foam pad 12, further locating and retaining the B-side surface 12B of the foam pad 12 against the surface 21 of first press half 20 during the pressing process.

The trim cover laminate 32 may be retained to the trim cover support portion 24 of the first press half 20. The trim cover support portion 24 includes means for retaining the trim cover laminate 32 during the pressing process described herein. In the illustrated embodiment, the means for retaining the trim cover 14 to the trim cover support portion 24 is an elastomeric band 36, however any other desired means may be used, such as clamps, straps, and the like. Additionally, the trim cover 14 may be retained against the trim cover support portion 24 by application of vacuum pressure from a vacuum source (not shown).

In a further step of the method of this invention, as best shown in FIG. 2, the source of IR energy 26 may be positioned or moved to a heating position between the first press half 20 and the second press half 22. In the heating position, the first heat generating surface 28 is facing the foam pad 12, and the second heat generating surface 30 is facing the adhesive film 16 of the trim cover laminate 32. A predetermined amount of IR energy may then be applied to the A-side surface 12A of the foam pad 12, and to the B-side surface 32B of the trim cover laminate 32. In one embodiment, the amount of IR energy emitted is sufficient to heat the A-side surface 12A of the foam pad 12 and the B-side surface 32B of the trim cover laminate 32 to within the range of from about 100 to about 150 degrees C., thereby activating or melting the exposed or B-side surface of the trim cover laminate 32. In the illustrated embodiment, the application of IR energy to the B-side surface 32B of the trim cover laminate 32 heats substantially only the B-side surface 32B of the trim cover laminate 32. Therefore, the application of IR energy does not significantly increase the temperature of the adjacent trim cover 14, substantially eliminating the occurrence of heat related damage to the trim cover 14, such as may occur in known seat cushion manufacturing methods.

Heating the A-side surface 12A of the foam pad 12 efficiently and effectively lengthens the amount of time heat energy remains in the pressing process described herein. It will be understood however, that the method of the present invention may be successfully practiced wherein a predetermined amount of IR energy is applied only to the B-side surface 32B of the trim cover laminate 32.

The emission of IR energy is then discontinued and the source of IR energy 26 may then be moved from between the press halves 20 and 22. The press halves 20 and 22 may then be moved to the closed position, as shown in FIG. 3. In the closed position, a force is applied to the trim cover laminate 32 and the foam pad 12, thereby positioning the trim cover laminate 32 onto the foam pad 12 to bring the A-side surface 12A of the foam pad 12 into contact with the melted adhesive film 16 of the trim cover laminate 32. The melted adhesive is allowed to cure or cool, thereby causing the trim cover 14 to become mechanically bonded or fused to the foam pad 12 to form the seat cushion 10.

The method of the present invention has been described in the context of providing a trim cover laminate 32. It will be understood, however, that an adhesive, such as the adhesive film 16, may be applied to the A-side surface 12A of the foam pad 12. The adhesive film 16 may be applied to the foam pad 12 by any desired method, such as by heat lamination as described herein. For example, as best shown in FIG. 4, the adhesive film 16 may be exposed to an amount of heat sufficient to laminate the adhesive film 16 to the A-side surface 12A of the foam pad 12, thereby defining a foam pad laminate, shown at 42 in FIG. 4. Alternately, the adhesive film 16, may be applied to both the A-side surface 12A of the foam pad 12. the B-side surface 14B of the trim cover 14. It will be further understood that the adhesive film 16 may be applied to the A-side surface 12A of the foam pad 12 and/or the B-side surface 14B of the trim cover 14 prior to the foam pad 12 and the trim cover 14 being placed in the press 18, or after the foam pad 12 and the trim cover 14 have been placed into the press 18.

If desired, one or more temperature sensors, such as the sensor schematically illustrated at 40 in FIGS. 2 and 4, may be provided to sense the temperature of the A-side surface 12A of the foam pad 12 and the B-side surface 32B of the trim cover laminate 32.

If further desired, the press 18, 18′ may include mechanical or electrical stops (not shown) to ensure that the press halves 20 and 22 are moved only to a predetermined distance from each other in the closed position.

Referring now to FIG. 4, and using like reference numbers to indicate corresponding parts, there is illustrated generally at 18′, a sectional view of a second alternate embodiment of the press 18 discussed above. The press 18′ is substantially identical to the press 18, except for the orientation of the press halves 20 and 22.

In the embodiment of the press 18′ illustrated in FIG. 4, the first press half 20 is positioned as the lower half of the press 18′, and the second press half 22 is positioned as the upper half of the press 18′. The structure and operation of the press 18′ is otherwise identical to that of the press 18.

The principle and mode of operation of this invention have been described in its various embodiments. However, it should be noted that this invention may be practiced otherwise than as specifically illustrated and described without departing from its scope.

What is claimed is:

1. A method of forming a fabric covered article, the method comprising the steps of:
providing a substrate;
providing a trim cover laminate comprising a trim cover portion and a heat-activated adhesive portion laminated to a B-side surface of the trim cover portion, the adhesive portion defining an exposed surface;
exposing the exposed surface of the adhesive portion to heat, thereby activating the adhesive portion; and
positioning the substrate onto the activated adhesive portion of the trim cover laminate to bring the substrate and the trim cover portion into contact with one another, thereby forming a fabric covered article.

2. The method according to claim 1, wherein the substrate is a foam pad.

3. The method according to claim 1, wherein the adhesive portion is an adhesive film.

4. The method according to claim 1, wherein the heat is provided from a source of radiant heat.

5. The method according to claim 4, wherein the source of radiant heat is a source of infrared energy.

6. The method according to claim 1, further including the step of applying a force to one of the substrate and the trim cover laminate to press the substrate onto the adhesive portion of the trim cover laminate, thereby accelerating the bond of the trim cover portion to the substrate.

7. The method according to claim 6, wherein the force applying step occurs in a press.

8. The method according to claim 7, wherein the step of exposing the exposed surface of the adhesive portion to heat occurs in the press prior to the application of force.

9. The method according to claim 1, wherein the trim cover portion comprises non-porous fabric.

10. The method according to claim 1, wherein the trim cover portion comprises leather.

11. The method according to claim 1, further including exposing an A-side surface of the substrate to heat.

12. The method according to claim 11, wherein the A-side surface of the substrate and the exposed surface of the adhesive portion are simultaneously exposed to heat.

13. The method according to claim 12, wherein the heat is provided from a source of radiant heat.

14. The method according to claim 13, wherein the source of radiant heat is a source of infrared energy.

15. A method of forming a fabric covered article, the method comprising the steps of:
disposing heat-activated adhesive on one of an A-side surface of a substrate and a B-side surface of a trim cover portion, the adhesive defining an exposed surface;
disposing the substrate and the trim cover portion in a press;
exposing the exposed surface of the adhesive to heat within the press, thereby activating the adhesive; and
positioning one of the substrate and the trim cover portion onto the other of the substrate and the trim cover portion having the activated adhesive thereon to bring the substrate and the trim cover portion into contact with one another, thereby forming a fabric covered article.

16. The method according to claim 15, wherein the heat is provided from a source of radiant heat.

17. The method according to claim 16, wherein the source of radiant heat is a source of infrared energy.

18. The method according to claim 15, further including the step of applying a force to one of the substrate and the trim cover portion to press the trim cover portion onto the substrate, thereby accelerating the bond of the trim cover portion to the substrate.

19. The method according to claim 15, further including exposing the A-side surface of the substrate and the B-side surface of the trim cover portion to heat.

20. A method of forming a fabric covered article, the method comprising the steps of:
laminating heat-activated adhesive on a B-side surface of a trim cover portion to define a trim cover laminate, the adhesive defining an exposed surface;
disposing a substrate and the trim cover laminate in a press;
exposing the exposed surface of the adhesive and an A-side surface of the substrate to infrared energy within the press, thereby activating the adhesive; and
applying a force to one of the substrate and the trim cover laminate to bring the substrate and the trim cover portion into contact with one another, thereby accelerating the bond of the trim cover portion to the substrate and forming a fabric covered article.
